(19) United States
(12) Patent Application Publication
(10) Pub. No.: US 2007/0264423 A1
(43) Pub. Date: Nov. 15, 2007

(54) MANUFACTURING METHOD OF TUNNEL MAGNETORESISTIVE EFFECT ELEMENT, MANUFACTURING METHOD OF THIN-FILM MAGNETIC HEAD, AND MANUFACTURING METHOD OF MAGNETIC MEMORY

(75) Inventors: Satoshi MIURA, Tokyo (JP); Takumi UESUGI, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TDK CORPORATION, Tokyo (JP)

(21) Appl. No.: 11/741,988

(22) Filed: Apr. 30, 2007

(30) Foreign Application Priority Data
May 11, 2006 (JP) 2006-132400

(51) Int. Cl. B05D 5/12; B05D 1/36; B05D 7/00

(52) U.S. Cl. 427/127; 427/402; 427/383.1

(57) ABSTRACT

A manufacturing method of a TMR element having a tunnel barrier layer sandwiched between lower and upper ferromagnetic layers. A fabricating process of the tunnel barrier layer includes a step of depositing a first metallic material film on the lower ferromagnetic layer, a step of oxidizing the deposited first metallic material film using an oxygen gas with a first pressure, a step of depositing a second metallic material film of the same material as that of the first metallic film or of metallic material containing primarily the same material as that of the first metallic film, on the oxidized first metallic film, and a step of oxidizing the deposited second metallic material film using an oxygen gas with a second pressure that is lower than the first pressure.

### PRIORITY CLAIM

This application claims priority from Japanese patent application No. 2006-132400, filed on May 11, 2006, which is incorporated herein by reference.

### BACKGROUND OF THE INVENTION

1. Field of the Invention

The present invention relates to a manufacturing method of a tunnel magnetoresistive effect (TMR) element, a manufacturing method of a thin-film magnetic head having a TMR element, and a manufacturing method of a magnetic memory.

2. Description of the Related Art

The TMR element has a ferromagnetic tunnel junction structure in which a tunnel barrier layer is sandwiched between two ferromagnetic layers, and an anti-ferromagnetic layer is arranged on a surface of one of the ferromagnetic layers, which surface is not contacting the tunnel barrier layer. Thus, one of these ferromagnetic layers functions as a magnetization-fixed layer, in which the magnetization of this ferromagnetic layer is hard to move in response to an external magnetic field due to exchange-coupling field with the anti-ferromagnetic layer. The other ferromagnetic layer functions as a magnetization-free layer, in which the magnetization is easy to change in response to the external magnetic field. With such a structure, the external magnetic field causes a relative orientation of the magnetization directions of the two ferromagnetic layers to change. The change of the relative magnetization orientation causes the probability of the electrons tunneling through the tunnel barrier layer to vary, to thereby change resistance of the element. Such a TMR element is usable as a read head element that detects intensity of magnetic field from a recording medium, and also applicable to a cell of magnetic RAM (MRAM) as a magnetic memory.

As material of the tunnel barrier layer in the TMR element, amorphous oxide of aluminum (Al) or titanium (Ti) has been generally used as disclosed for example in U.S. Pat. No. 6,710,987.

Recently, there has been proposed a TMR element using a tunnel barrier layer made of crystalline oxide of magnesium (Mg). Such TMR element using the tunnel barrier layer of Mg oxide can have a higher MR ratio (magnetoresistive change ratio) compared with the TMR element with a tunnel barrier layer of Al oxide or Ti oxide as disclosed in U.S. Patent Publication No. 2006/0056115A1.

The tunnel barrier layer of crystalline Mg oxide is usually formed by deposition of magnesium oxide (MgO), that is, by an RF sputtering method using a target of MgO. However, if the MgO target is used, it is unavoidable to have uneven resistance among substrates, caused by uneven resistance due to film-thickness distribution of an MgO film on a substrate and by variation of film-deposition speed of the MgO film by the RF sputtering.

In order to solve this problem, it has been attempted that an MgO film is formed by oxidizing a deposited Mg film. In this case, it is advantageous that an additional Mg film is deposited on the MgO film to restrain oxidation of a ferromagnetic film in the magnetization-free layer formed on the MgO layer. By restraining oxidation of the ferromagnetic film, it may be possible to obtain TMR elements having a high MR ratio.

However, because the Mg film additionally deposited on the MgO film will have a part indicating metallic characteristic due to insufficient oxidation, it is impossible to obtain enough performance as for an MgO barrier.

U.S. Pat. No. 6,710,987 discloses that a tunnel barrier layer made of aluminum oxide is obtained by depositing an Al film, by oxidizing the deposited Al film to form an aluminum oxide (AlO_{X}) film, by depositing an additional Al film thereon, and then by oxidizing the deposited additional Al film to form an AlO_{X} film. U.S. Pat. No. 6,710,987 also discloses that Mg may be used instead of Al. However, an oxidation process with actual use of Mg is not disclosed at all. Also, in this publication, conditions of two oxidation processes are silent.

### SUMMARY OF THE INVENTION

It is therefore an object of the present invention to provide a manufacturing method of a TMR element, a manufacturing method of a thin-film magnetic head and a manufacturing method of a magnetic memory, whereby it is possible to stably obtain a high quality TMR film having a barrier layer with less pinholes and to provide a TMR element having a high MR ratio.

According to the invention, a manufacturing method of a TMR element having a tunnel barrier layer sandwiched between lower and upper ferromagnetic layers. A fabricating process of the tunnel barrier layer includes a step of depositing a first metallic material film on the lower ferromagnetic layer, a step of oxidizing the deposited first metallic material film using an oxygen (O₂) gas with a first pressure, a step of depositing a second metallic material film of the same material as that of the first metallic film or of metallic material containing primarily the same material as that of the first metallic film, on the oxidized first metallic film, and a step of oxidizing the deposited second metallic material film using an O₂ gas with a second pressure that is lower than the first pressure.

If a magnetization-free layer is directly laminated on the first oxidized metallic material film, a ferromagnetic layer in the magnetization-free layer will be oxidized. Thus, in order to prevent the oxidation of the ferromagnetic layer, the second metallic material film is deposited on the oxidized first metallic material film. Because the oxidation of the ferromagnetic layer can be suppressed, it is possible to increase the MR ratio. However, if there is a part indicating metallic characteristic in the deposited second metallic material film, it is impossible to obtain enough performance as for the tunnel barrier layer. Thus, it is necessary to also oxidize this second metallic material film. In the oxidation of the second metallic material film, weak oxidation that will not oxidize the ferromagnetic layer in the magnetization-free layer is performed. In other words, the second metallic material film is oxidized under the weaker O₂ gas pressure lower than that in the oxidation of the first metallic material film. As a result, it is possible to oxidize the second metallic material film to make the oxidized second metallic material film without exerting influence of the oxidization upon the ferromagnetic layer in the magnetization-free layer and therefore to greatly increase the MR ratio of the TMR read head element.

It is preferred that the metallic material is Mg or metallic material containing Mg.

It is also preferred that the oxidizing step of the deposited first metallic material film and/or the oxidizing step of the deposited second metallic material film include oxidizing the deposited first metallic material film and/or oxidizing the deposited second metallic material film by performing flow oxidation.

It is further preferred that the oxidizing step of the deposited first metallic material film and/or the oxidizing step of the deposited second metallic material film comprise oxidizing the deposited first metallic material film and/or oxidizing the deposited second metallic material film by performing natural oxidation in an oxidation chamber.

According to the invention, also, a manufacturing method of a thin-film magnetic head with a TMR read head element, and a manufacturing method of a magnetic memory with cells using the manufacturing method described above are provided.

Further objects and advantages of the present invention will be apparent from the following description of the preferred embodiments of the invention as illustrated in the accompanying drawings.

### BRIEF DESCRIPTION OF THE DRAWINGS

FIG. 1 is a flow chart illustrating a fabrication process of a thin-film magnetic head in a preferred embodiment according to the present invention;

FIG. 2 is a cross-sectional view schematically illustrating a structure of the thin-film magnetic head produced according to the fabrication process shown in FIG. 1;

FIG. 3 is a flow chart illustrating in more detail a fabrication process of a read head element in the fabrication process shown in FIG. 1;

FIG. 4 is a cross-sectional view schematically illustrating a structure of the read head element part of the thin-film magnetic head shown in FIG. 2; and

FIG. 5 is a characteristic diagram illustrating the relationship between an element resistance RA and an MR ratio when only a first oxidation process is performed and when first and second oxidation processes are performed.

### DESCRIPTION OF THE PREFERRED EMBODIMENTS

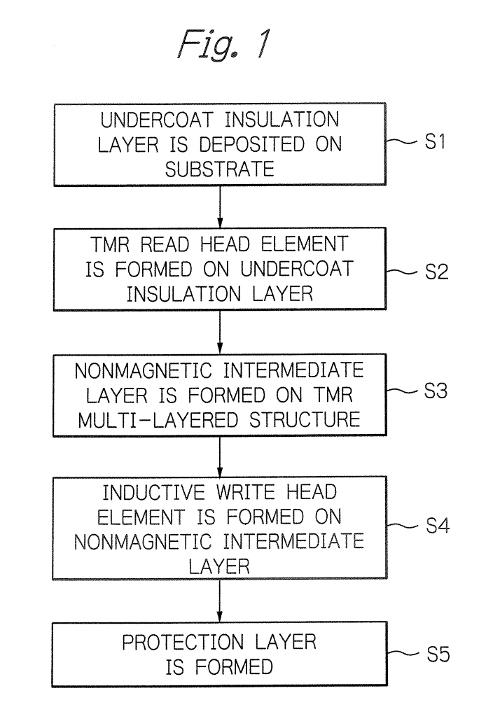

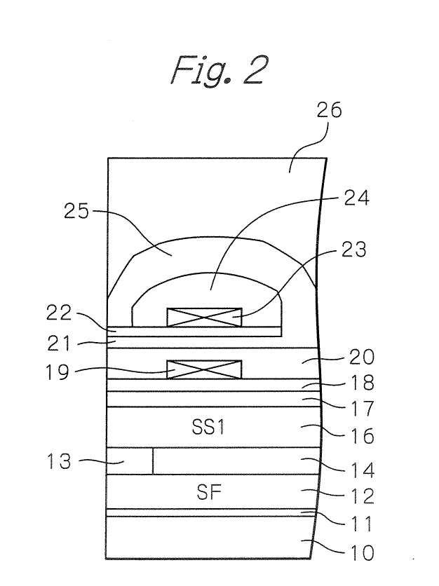

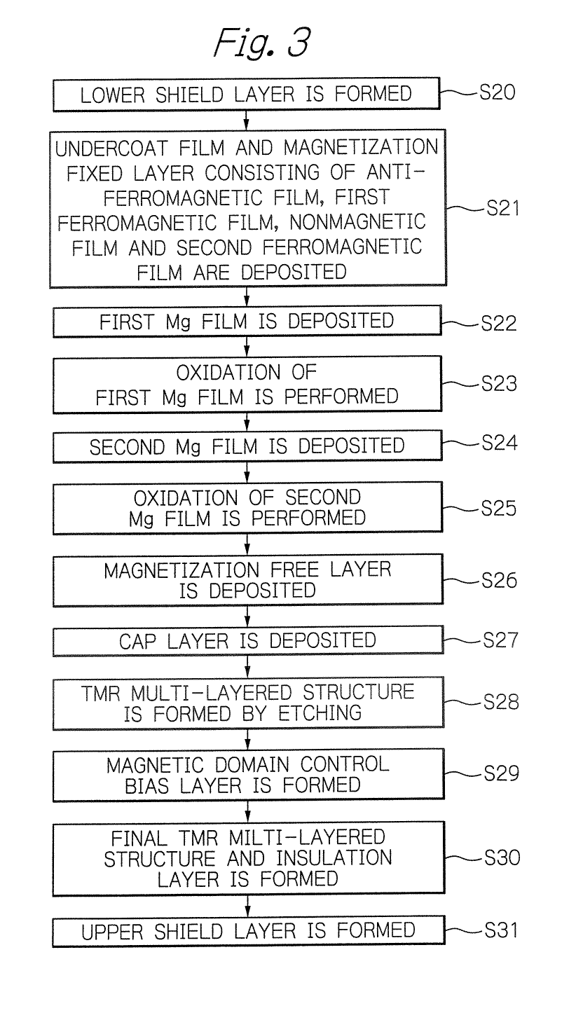

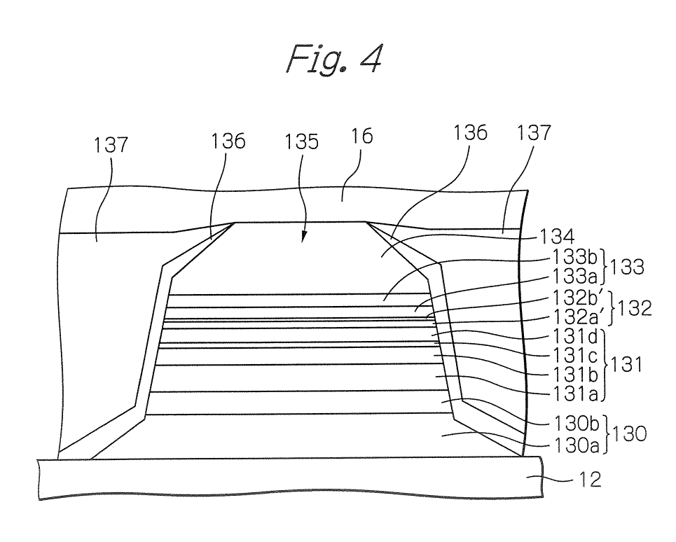

FIG. 1 illustrates a flow of a fabrication process of a thin-film magnetic head in a preferred embodiment according to the present invention, FIG. 2 schematically illustrates a structure of the thin-film magnetic head produced according to the fabrication process shown in FIG. 1, FIG. 3 illustrates in more detail a fabrication process of a read head element part in the fabrication process shown in FIG. 1, and FIG. 4 schematically illustrates a structure of the read head element part in the thin-film magnetic head shown in FIG. 2. It should be noted that FIG. 2 shows a cross section of the thin-film magnetic head on a plane perpendicular to an air bearing surface (ABS) and a track width direction, and FIG. 4 shows a cross section seen from the ABS direction.

As shown in FIGS. 1 and 2, a substrate or wafer 10 made of conductive material such as ALTIC (AlTiC, Al₂O₃—TiC) is first prepared. On the substrate 10, an undercoat insulation layer 11 is formed by deposition of insulation material such as aluminum oxide or alumina (Al₂O₃) or silicon dioxide (SiO₂) with a thickness of about 0.05-10 μm, using a sputtering method for example (Step S1).

Then, on the undercoat insulation layer 11, a TMR read head element containing a lower shield layer (SF) 12 used also as a lower electrode layer, a TMR multi-layered structure 13, an insulation layer 14, domain control bias layers 137 (see FIG. 4) and an upper shield layer (SS1) 16 used also as an upper electrode layer is formed (Step S2). The fabrication process of this TMR read head element will be described in detail later.

Then, on the TMR read head element, a nonmagnetic intermediate layer 17 is formed by deposition of insulation material such as Al₂O₃, SiO₂, aluminum nitride (AlN) or diamond-like carbon (DLC), or metallic material such as Ti, tantalum (Ta) or platinum (Pt) with a thickness of about 0.1-0.5 μm, using for example a sputtering method or a chemical vapor deposition (CVD) method (Step S3). This nonmagnetic intermediate layer 17 is provided for separating the TMR read head element from an inductive write head element formed over the read head.

Thereafter, on the nonmagnetic intermediate layer 17, an inductive write head element is formed (Step S4). This inductive write head element contains an insulation layer 18, a backing coil layer 19, a backing coil insulation layer 20, a main pole layer 21, an insulation gap layer 22, a write coil layer 23, a write coil insulation layer 24 and an auxiliary pole layer 25. Although in this embodiment the inductive write head element with a structure of perpendicular magnetic recording is used, it is apparent that an inductive write head element with a structure of horizontal or in-plane magnetic recording can be used in modifications. Also, as an inductive write head element with a perpendicular magnetic recording structure, various structures other than that shown in FIG. 2 are applicable.

The insulation layer 18 is formed by deposition of insulation material such as Al₂O₃ or SiO₂, on the nonmagnetic intermediate layer 17, using a sputtering method. The surface of the insulation layer 18 may be flattened by for example a chemical mechanical polishing (CMP) method as needed. On the insulation layer 18, the backing coil layer 19 is formed by plating of conductive material such as Cu with a thickness of about 1-5 μm, using a frame plating method for example. The backing coil layer 19 is provided for inducing writing flux to avoid adjacent-track erasure (ATE). The backing coil insulation layer 20 is formed from thermally cured resist material such as novolak resist with a thickness of about 0.5-7 μm, using a photolithography method for example, to cover the backing coil layer 19.

The main pole layer 21 is formed on the backing coil insulation layer 20. This main pole layer 21 functions as a magnetic path for guiding and converging the magnetic flux, induced by the write coil layer 23, into a perpendicular magnetic recording layer of a magnetic disk to be written thereon. The main pole layer 21 is formed by plating of metal magnetic material such as FeAlSi, NiFe, CoFe, NiFeCo, FeN, FeZrN, FeTaN, CoZrNb or CoZrTa, or a multi-layered film of these materials with a thickness of about 0.5-3 μm, using a frame-plating method for example.

The insulating gap layer 22 is formed on the main pole layer 21 by deposition of an insulating film of Al₂O₃ or SiO₂, using sputtering method for example. On the insulating gap layer 22, the write coil insulation layer 24 is formed from thermally cured resist material such as novolak resist with a thickness of about 0.5-7 μm, using a photolithography method for example. Inside the insulation layer 24, the write coil layer 23 is formed by plating of conductive material such as Cu with a thickness of about 1-5 μm, using a frame-plating method for example.

The auxiliary pole layer 25 is formed by plating of metal magnetic material such as FeAlSi, NiFe, CoFe, NiFeCo, FeN, FeZrN, FeTaN, CoZrNb or CoZrTa, or a multi-layered film including these materials with a thickness of about 0.5-3 μm, using a frame-plating method for example to cover the write coil insulation layer 24. This auxiliary pole layer 25 constitutes a return yoke.

Subsequently, the protection layer 26 is formed on the inductive write head element (Step S5). The protection layer 26 is formed by deposition of for example Al₂O₃ or SiO₂, using a sputtering method for example.

Upon finishing the above process, the wafer process of the thin-film magnetic head ends. A manufacturing process of the magnetic head after the wafer process, for example a machining process, is well known, and therefore the description thereof is omitted.

Hereinafter, a detailed description will be given of a fabrication process of the TMR read head element with reference to FIGS. 3 and 4.

First, on the undercoat insulation layer 11, the lower shield layer (SF) 12 used also as a lower electrode layer is formed by plating of metal magnetic material such as FeAlSi, NiFe, CoFe, NiFeCo, FeN, FeZrN, FeTaN, CoZrNb or CoZrTa with a thickness of about 0.1-3 μm, using a frame-plating method for example (Step S20).

Next, on the lower shield layer 12, a first undercoat film 130a and a second undercoat film 130b are deposited in this order using a sputtering method for example. The first undercoat layer 130a is formed from for example Ta, hafnium (Hf), niobium (Nb), zirconium (Zr), Ti, molybdenum (Mo) or tungsten (W) with a thickness of about 0.5-5 nm. The second undercoat film 130b is formed from for example NiCr, NiFe, NiFeCr or Ru with a thickness of about 1-5 nm. The first undercoat film 130a and the second undercoat film 130b constitute a multi-layered undercoat film 130. Then, an anti-ferromagnetic film 131a, a first ferromagnetic film 131b, a nonmagnetic film 131c and a second ferromagnetic film 131d are deposited in this order using a sputtering method for example (Step S21). The anti-ferromagnetic film 131a is formed from for example IrMn, PtMn, NiMn or RuRhMn with a thickness of about 5-15 nm. The first ferromagnetic film 131b is formed from for example CoFe with a thickness of about 1-5 nm. The nonmagnetic film 131c is formed from for example one or more of ruthenium (Ru), rhodium (Rh), iridium (Ir), chromium (Cr), rhenium (Re) and copper (Cu) alloys with a thickness of about 0.8 nm. The second ferromagnetic film 131d of two-layered structure is formed from for example a ferromagnetic film of CoFeB with a thickness of about 1-3 nm and a ferromagnetic film of CoFe with a thickness of about 0.2-3 nm. The anti-ferromagnetic film 131a, the first ferromagnetic film 131b, the nonmagnetic film 131c and the second ferromagnetic film 131d constitute a synthetic magnetization-fixed layer 131.

Then, on the formed second ferromagnetic film 131d, a first metallic film with a thickness of about 0.3-1 nm, more concretely in the embodiment, a first Mg film 132a that may be a metallic film containing Mg or a Mg film with a thickness of 0.8 nm is formed, using a sputtering method for example (Step S22).

Thereafter, the stacked film is transferred into an oxidation chamber, and oxidation of the first Mg film 132a is performed (Step S23). This oxidation may be performed by a so-called natural oxidation process in which O₂ gas only or O₂ gas with clean gas is induced into the vacuum-sealed oxidation chamber up to a predetermined pressure and oxidation is executed, or by a flow oxidation process in which, while discharging gas from the oxidation chamber by a vacuum pump, O₂ gas only or O₂ gas with clean gas is induced into the oxidation chamber and oxidation is executed under volumes of process gas. The clean gas may be at least one kind of, for example, rare gas including helium (He) gas, neon (Ne) gas, argon (Ar) gas, krypton (Kr) gas or xenon (Xe) gas, nitrogen (N₂) gas and hydrogen (H₂) gas. According to this oxidation, a first Mg-oxide film 132a′ that constitutes a part of a tunnel barrier layer is formed.

Then, in order to suppress oxidation, due to the first Mg-oxide film 132a′, of a ferromagnetic layer (magnetization-free layer) formed on the tunnel barrier layer, a second metallic film of the same material as of the first Mg film 132a or of metallic material containing primarily the same material, that is in the embodiment a second Mg film 132b with a thickness of 0.3 nm, is further deposited using a sputtering method for example (Step S24).

Thereafter, the stacked film is transferred into an oxidation chamber, and oxidation of the second Mg film 132b is performed (Step S25). This oxidation may be performed by a so-called natural oxidation process in which O₂ gas only or O₂ gas with clean gas is induced into the vacuum-sealed oxidation chamber up to a predetermined pressure and oxidation is executed, or by a flow oxidation process in which, while discharging gas from the oxidation chamber by a vacuum pump, O₂ gas only or O₂ gas with clean gas is induced into the oxidation chamber and oxidation is executed under volumes of process gas. The clean gas may be at least one kind of, for example, rare gas including He gas, Ne gas, Ar gas, Kr gas or Xe gas, N₂ gas and H₂ gas. According to this oxidation, a second Mg-oxide film 132b′ that constitutes a part of a tunnel barrier layer is formed, and thus the tunnel barrier layer 132 is finally formed.

It is important in this embodiment that a pressure of O₂ gas at the second oxidation process for the second Mg film 132b is determined to a value lower than that at the first oxidation process for the first Mg film 132a. Namely, according to this embodiment, in the second oxidation process, weaker oxidation that will not oxidize the ferromagnetic film in the magnetization-free layer formed on the tunnel barrier layer 132 but the second Mg film 132b is oxidized to make the second Mg oxide film 132b′ is performed. As a result, the MR ratio of the TMR read head element can be increased.

Although it is a mere example, when the O₂ gas pressure at the first oxidation process is controlled at 6.2E-02 (Pa) and the O₂ gas pressure at the second oxidation process is controlled at 1.0E-04 (Pa) that is extremely lower than that at the first oxidation process, the MR ratio of the TMR element can be extremely increased.

Alternatively, for the material of the tunnel barrier layer, metallic material more reactive to oxygen than Ti, Ta, Al, Zr, Hf, germanium (Ge), silicon (Si) or zinc (Zn) may be used instead of Mg.

Thereafter, on the tunnel barrier layer 132 thus formed, a high polarization-rate film 133a of CoFe for example with a thickness of about 1 nm, and a soft magnetic film 133b of NiFe for example with a thickness of about 2-6 nm are serially deposited, using a sputtering method for example, to form a magnetization-free layer 133 (Step S26).

Then, a cap layer 134 having one layer or two layers or more of Ta, Ru, Hf, Nb, Zr, Ti, Cr or W with a thickness of about 1-20 nm is deposited, using a sputtering method for example (Step S27). According to the above processes, a TMR multi-layered film is formed.

Each film configurations of a magnetic-field sensitive part consisting of the magnetization-fixed layer 131, the tunnel barrier layer 132 and the magnetization-free layer 133 is not limited to the above-described configuration, but various kinds of material and film thickness may be applicable thereto. For instance, as for the magnetization-fixed layer 131, there may be employed the anti-ferromagnetic film plus a single-layer structure of ferromagnetic film or the anti-ferromagnetic film plus a multi-layered structure with other number of layers, other than the anti-ferromagnetic film plus the three-layer structure. Furthermore, as for the magnetization-free layer 133, there may be employed a single-layer structure with no high polarization-rate film or a multi-layered structure of more than three layers with a magnetostrictive adjustment film, other than the two-layer structure. Still further, as for the magnetic-field sensitive part, the magnetization-fixed layer, the tunnel barrier layer and the magnetization-free layer may be stacked in reverse order, that is, stacked in the order of the magnetization-free layer, the tunnel barrier layer and the magnetization-fixed layer from the bottom. In the latter case, the anti-ferromagnetic film within the magnetization-fixed layer is positioned at the top.

Then, a TMR multi-layered structure 135 is formed by etching the TMR multi-layered film (Step S28). This etching process is performed for example by forming, on the TMR multi-layered film, a resist as a resist pattern for a liftoff, and then by applying ion beam of Ar ions through the resist mask to the TMR multi-layered film.

After formation of the TMR multi-layered structure 135, an insulation layer 136 of for example Al₂O₃ or SiO₂ with a thickness of about 3-20 nm, a bias undercoat layer of for example Ta, Ru, Hf, Nb, Zr, Ti, Mo, Cr or W, and a magnetic domain controlling bias layer 137 of fro example CoFe, NiFe, CoPt or CoCrPt are serially formed in this order, using sputtering method for example. Thereafter, the resist is peeled off by the liftoff to form a magnetic domain control bias layer 15 (Step S29).

Then, the TMR multi-layered structure 135 is further patterned using a photolithography method for example to obtain a final TMR multi-layered structure 13, and subsequently an insulation layer 14 is deposited using a sputtering method or an ion beam sputtering method for example (Step S30).

Thereafter, on the insulation layer 14 and the TMR multi-layered structure 13, an upper shield layer (SS1) 16 used also as an upper electrode layer of metal magnetic material such as FeAlSi, NiFe, CoFe, NiFeCo, FeN, FeZrN, FeTaN, CoZrNb or CoZrTa, or a multi-layered film containing these materials with a thickness of about 0.5-3 μm is formed, using a frame-plating method for example (Step S31). According to the above-mentioned processes, formation of the TMR read head is completed.

Hereinafter, the two oxidation processes for fabricating the tunnel barrier layer in the embodiment will be described in detail.

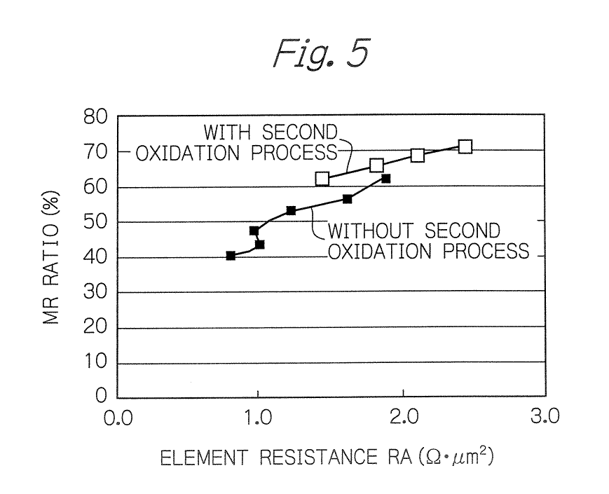

Actually, samples of the TMR multi-layered structure were fabricated by performing the similar manner as mentioned above and MR ratios the fabricated samples were measured. Namely, as for each sample, a first Mg film 132a was deposited, the deposited Mg film 132a was oxidized (first oxidation process) with an O₂ gas pressure of 6.2E-02 (Pa), a second Mg film 132b was deposited, and no oxidation of the deposited second Mg film 132b was performed. Then, the MR ratios of these samples formed without second oxidation process were measured. Also, as for each sample, a first Mg film 132a was deposited, the deposited Mg film 132a was oxidized (first oxidation process) with an O₂ gas pressure of 6.2E-02 (Pa), a second Mg film 132b was deposited, and the deposited second Mg film 132b was oxidized (second oxidation process) with an O₂ gas pressure of 1.0E-04 (Pa) that is extremely lower than that at the first oxidation process. Then, the MR ratios of these samples formed with second oxidation process were measured. The measured result is shown in FIG. 5. In the figure, the lateral axis indicates the element resistance RA. Different element resistances RA of the samples were obtained by changing the time period of the first oxidation.

As will be noted from the figure, the MR ratio of the TMR element formed with second oxidation process is higher than that of the TMR element formed with no second oxidation process even if they have the same element resistance RA. This is because the second Mg film 132b was oxidized under the weaker O₂ gas pressure that will not oxidize the magnetization-free layer 133 but will oxidize whole of the second Mg film 132b to make the second Mg oxide film 132b′ and to remain no metallic Mg part. In general, the magnetization-free layer 133 will not be oxidized due to weak oxidation. However, if it is worried that the magnetization-free layer may be affected from the oxidation, an additional Mg film can be deposited on the second Mg-oxide film 132b′.

As for an evaluation method of the quality of the tunnel barrier layer, there is a method of measuring breakdown voltage of the TMR element having this tunnel barrier layer. If the area of the TMR element is sufficiently small with respect to a density of pinholes in its tunnel barrier layer, presence or absence of pinholes in the tunnel barrier layers will occur even if the TMR elements are formed on the same wafer and then the breakdown voltages measured will be separated in two groups. Suppose the pinholes distribute depending upon the Poisson distribution, the TMR elements with a high breakdown voltage are considered as that with no pinhole in the tunnel barrier layers. Then, it is possible to estimate a density of pinholes from the ratio of the TMR elements with no pinhole in their tunnel barrier layers and the area of the TMR element.

The obtained result of element resistances RA, MR ratios and pinhole density D of the TMR elements is indicated in Table 1.

TABLE 1

| | Element | | Density of |
|---|---|---|---|
| | Resistance | MR Ratio | Pinholes D |
| | RA (Ω · μm²) | (%) | (piece/μm²) |
| Formed Without | 2.4 | 55 | 82.1 |
| Second Oxidation | | | |
| Process | | | |
| Formed With | 2.5 | 68 | 17.4 |
| Second Oxidation | | | |
| Process | | | |

As will be understood from the table, by performing the second oxidation, not only the MR ratio increases but also the pinhole density D is greatly reduced. It is considered that, by performing the second oxidation, the number of pinholes in the Mg oxide barrier layer is reduced and thus the quality of the barrier layer is improved to increase the MR ratio.

As described above, if the magnetization-free layer 133 is directly laminated on the first Mg oxide film 132a′, the ferromagnetic film in the magnetization-free layer 133 will be oxidized. Thus, in order to prevent the oxidation of the ferromagnetic film, the second Mg film 132b is deposited on the first Mg oxide film 132a′. Because the oxidation of the ferromagnetic film can be suppressed, it is possible to increase the MR ratio. However, if there is a part indicating metallic characteristic in the deposited second Mg film 132b, it is impossible to obtain enough performance as for the tunnel barrier layer. Thus, it is necessary to also oxidize this second Mg film 132b. In the oxidation of the second Mg film 132b, according to this embodiment, weak oxidation that will not oxidize the ferromagnetic film in the magnetization-free layer 133 is performed. In other words, the second Mg film 132b is oxidized under the weaker O₂ gas pressure lower than that in the oxidation of the first Mg film 132a. As a result, it is possible to oxidize the second Mg film 132b to make the second Mg oxide film 132b′ without exerting influence of the oxidization upon the ferromagnetic film in the magnetization-free layer 133 and therefore to greatly increase the MR ratio of the TMR read head element.

The aforementioned embodiment concerns a manufacturing method of a thin-film magnetic head with a TMR read head element. The present invention is similarly applicable to a manufacturing method of a magnetic memory such as an MRAM cell. As is known, each MRAM cell has a TMR structure with a magnetization-fixed layer, a tunnel barrier layer, a magnetization-free layer and an upper conductive layer acting as a word line serially stacked on a lower conductive layer acting as a bit line.

Many widely different embodiments of the present invention may be constructed without departing from the spirit and scope of the present invention. It should be understood that the present invention is not limited to the specific embodiments described in the specification, except as defined in the appended claims.

1. A manufacturing method of a tunnel magnetoresistive effect element having a tunnel barrier layer sandwiched between lower and upper ferromagnetic layers, a fabricating process of said tunnel barrier layer comprising the steps of:
depositing a first metallic material film on said lower ferromagnetic layer;
oxidizing the deposited first metallic material film using an oxygen gas with a first pressure;
depositing a second metallic material film of the same material as that of said first metallic film or of metallic material containing primarily the same material as that of said first metallic film, on the oxidized first metallic film; and
oxidizing the deposited second metallic material film using an oxygen gas with a second pressure that is lower than said first pressure.

2. The manufacturing method as claimed in claim 1, wherein said first metallic material film is made of magnesium or metallic material containing magnesium.

3. The manufacturing method as claimed in claim 1, wherein the oxidizing step of said deposited first metallic material film and/or the oxidizing step of said deposited second metallic material film comprise oxidizing said deposited first metallic material film and/or oxidizing said deposited second metallic material film by performing flow oxidation.

4. The manufacturing method as claimed in claim 1, wherein the oxidizing step of said deposited first metallic material film and/or the oxidizing step of said deposited second metallic material film comprise oxidizing said deposited first metallic material film and/or oxidizing said deposited second metallic material film by performing natural oxidation in an oxidation chamber.

5. A manufacturing method of a thin-film magnetic head with a tunnel magnetoresistive effect read head element having a tunnel barrier layer sandwiched between lower and upper ferromagnetic layers, a fabricating process of said tunnel barrier layer comprising the steps of:
depositing a first metallic material film on said lower ferromagnetic layer;
oxidizing the deposited first metallic material film using an oxygen gas with a first pressure;
depositing a second metallic material film of the same material as that of said first metallic film or of metallic material containing primarily the same material as that of said first metallic film, on the oxidized first metallic film; and
oxidizing the deposited second metallic material film using an oxygen gas with a second pressure that is lower than said first pressure.

6. A manufacturing method of a magnetic memory with cells, each cell including a tunnel magnetoresistive effect element having a tunnel barrier layer sandwiched between lower and upper ferromagnetic layers, a fabricating process of said tunnel barrier layer comprising the steps of:
depositing a first metallic material film on said lower ferromagnetic layer;
oxidizing the deposited first metallic material film using an oxygen gas with a first pressure;
depositing a second metallic material film of the same material as that of said first metallic film or of metallic material containing primarily the same material as that of said first metallic film on the oxidized first metallic film; and
oxidizing the deposited second metallic material film using an oxygen gas with a second pressure that is lower than said first pressure.
